(19) United States
(12) Patent Application Publication
(10) Pub. No.: US 2019/0179167 A1
(43) Pub. Date: Jun. 13, 2019

(54) PROGRESSIVE ADDITION LENS AND PROGRESSIVE ADDITION GLASSES

(71) Applicant: HON HAI PRECISION INDUSTRY CO., LTD., New Taipei (TW)

(72) Inventor: WEN-KAI LI, New Taipei (TW)

(21) Appl. No.: 15/859,765

(22) Filed: Jan. 2, 2018

(30) Foreign Application Priority Data
Dec. 13, 2017 (CN) 201711329520.7

(51) Int. Cl. G02C 7/06

(52) U.S. Cl. CPC G02C 7/061; G02C 2202/18

(57) ABSTRACT

A progressive addition lens comprises a first lens layer, a second lens layer attached to a surface of the first lens layer, and a third lens layer attached to a surface of the second lens layer away from the first lens layer. The first lens layer, the second lens layer, and the third lens layer are made of different materials, thus refractive index of each layer is different, thus a visual acuity of the progressive addition lens is high. A progressive addition glasses using the progressive addition lens is also provided.

### FIELD

The subject matter herein generally relates to a progressive addition lens, and a progressive addition glasses using the progressive addition lens.

### BACKGROUND

Progressive addition lenses are usually described as having three zones: an upper zone for far vision, a lower zone for near vision, and an intermediate progression corridor that bridges the first two zones. People wearing the progressive addition lens can achieve a continuous clear vision from a far point to a near point. However visual acuity of the existing progressive addition lens is low. Thereby a progressive addition lens with a high visual acuity is needed.

### BRIEF DESCRIPTION OF THE DRAWINGS

Implementations of the present disclosure will now be described, by way of example only, with reference to the attached figures.

FIG. 1 is a diagrammatic view of a progressive addition lens according to an exemplary embodiment of the present disclosure.

FIG. 2 is a cross-sectional view taken along line II-II of FIG. 1 according to a first exemplary embodiment of the present disclosure.

FIG. 3 is a cross-sectional view taken along line II-II of FIG. 1 according to a second exemplary embodiment of the present disclosure.

FIG. 4 is a diagrammatic view of a progressive addition glasses according to an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like. The term “about” when utilized, means “not only includes the numerical value, but also includes numbers closest to the numerical value”.

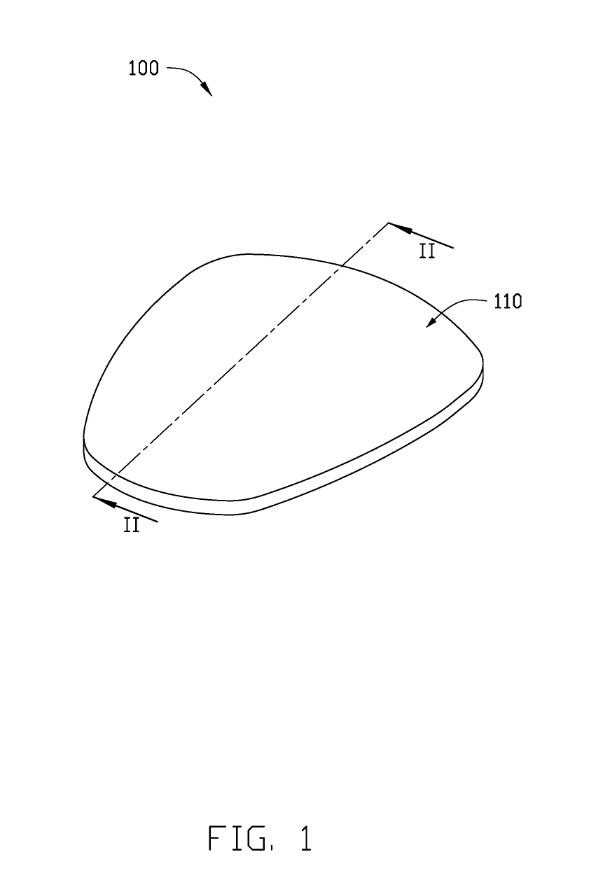

FIG. 1 illustrates a progressive addition lens 100 including a first lens layer 10, a second lens layer 20 attached to a surface of the first lens layer 10, and a third lens layer 30 attached to a surface of the second lens layer 20 away from the first lens layer 10.

The first lens layer 10, the second lens layer 20, and the third lens layer 30 are made of different materials. A refractive index of the first lens layer 10, a refractive index of the second lens layer 20, and a refractive index of the third lens layer 30 are all different, thus a visual acuity of the progressive addition lens 100 is high.

The first lens layer 10 is made of solid material. The solid material may be selected from polycarbonate, cyclic block copolymer (CBC), polymethyl methacrylate (PMMA), or any combination thereof.

The second lens layer 20 is made of solid material, liquid material, gas material, or any combination thereof. The solid material may be selected from polycarbonate, cyclic block copolymer (CBC), polymethyl methacrylate (PMMA), or any combination thereof. The liquid material may be selected from water, silicone oil, or combination thereof. The gas material may be selected from air, oxygen, nitrogen, or any combination thereof.

The third lens layer 30 is made of solid material. The solid material may be selected from polycarbonate, cyclic block copolymer (CBC), polymethyl methacrylate (PMMA), or any combination thereof.

In at least one exemplary embodiment, the progressive addition lens 100 further includes at least one coating layer 40. The at least one coating layer 40 is attached on the front surface 110 and/or the back surface 120.

The coating layer 40 may be an anti-scratch layer, an anti-reflection layer, an anti-fog layer, an anti-dust layer, a water-repelling layer, or an anti-UV layer.

The progressive addition lens 100 includes a front surface 110, and a back surface 120 opposite to the front surface 110. The front surface 110 may be a spherical surface or an aspherical surface. The back surface 120 may be a spherical surface or an aspherical surface.

In at least one exemplary embodiment, a thickness of the first lens layer 10, a thickness of the second lens layer 20, and a thickness of the third lens layer 30 are equal. In other exemplary embodiment, the thickness of the first lens layer 10, the thickness of the second lens layer 20, and the thickness of the third lens layer 30 are not equal.

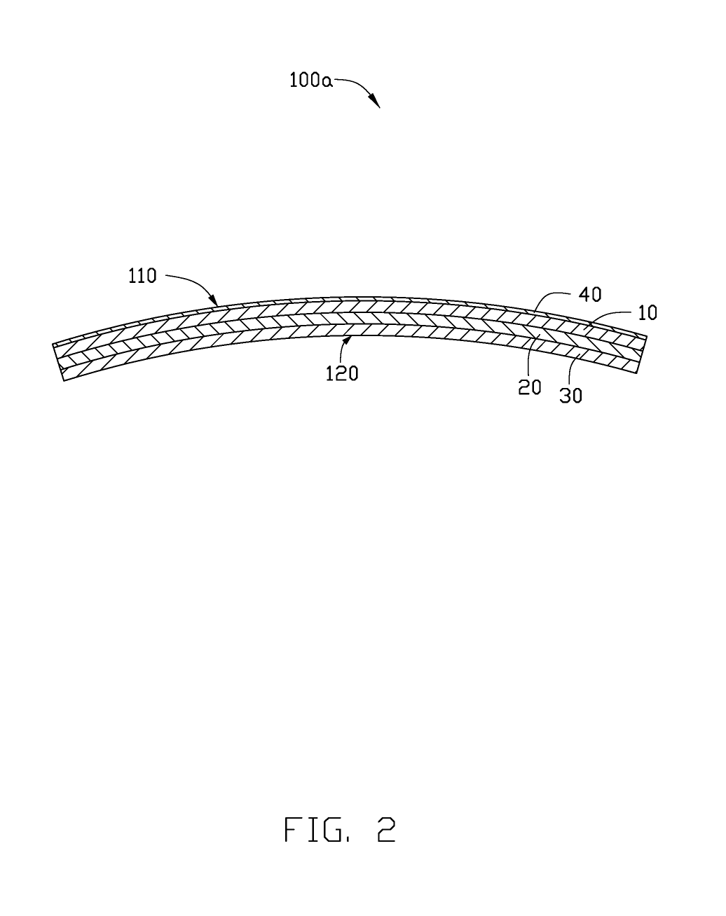

FIG. 2 illustrates a first embodiment of a progressive addition lens 100a. The second lens layer 20 of the progressive addition lens 100a is made of solid material. The first lens layer 10, the second lens layer 20, and the third lens layer 30 are stacked one after another.

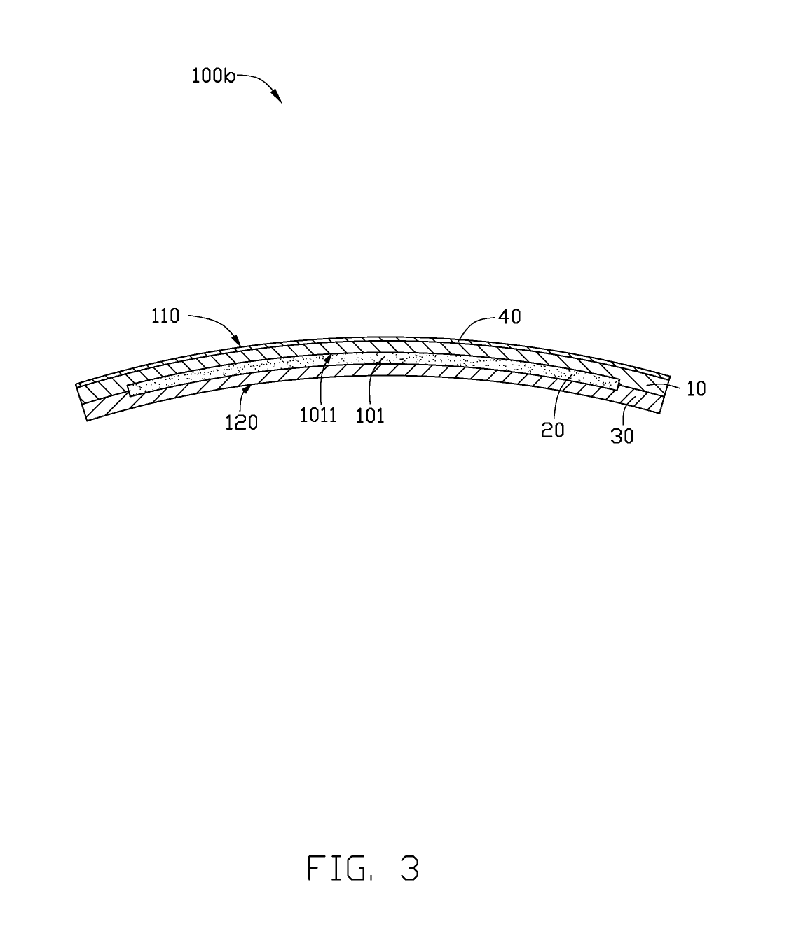

FIG. 3 illustrates a second embodiment of a progressive addition lens 100b. The second lens layer 20 of the progressive addition lens 100b is made of liquid material or gas material. The first lens layer 10 and the third lens layer 30 form a cavity 101. The liquid material or the gas material is filled in the cavity 101, to form the second lens layer 20.

A shape of the cavity 101 is not limited. In at least one exemplary embodiment, the cavity 101 has a cuboid shape.

The cavity 101 includes at least one cavity wall 1011. The cavity wall 1011 may have a shape of flat surface or a curved surface.

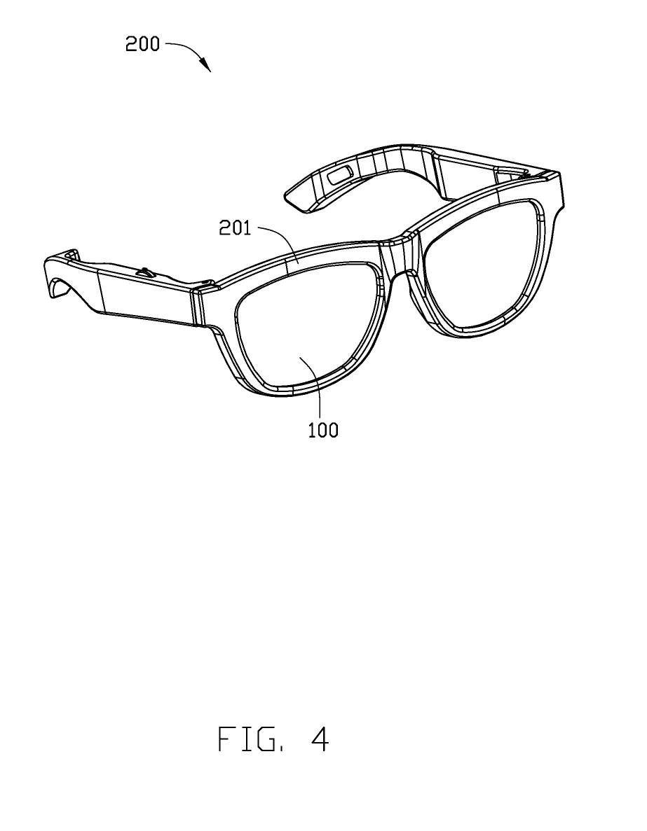

FIG. 4 illustrates a progressive addition glasses 200. The progressive addition glasses 200 includes a glasses frame 201, and two progressive addition lenses 100 embedded on the glasses frame 201.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A progressive addition lens comprising:
a first lens layer;
a second lens layer attached to a surface of the first lens layer; and
a third lens layer attached to a surface of the second lens layer away from the first lens layer;
wherein the first lens layer, the second lens layer, and the third lens layer are made of different materials.

2. The progressive addition lens of claim 1, wherein the first lens layer and the third lens layer are made of solid material.

3. The progressive addition lens of claim 2, wherein the second lens layer is made of solid material, liquid material or gas material.

4. The progressive addition lens of claim 3, wherein the solid material is selected from polycarbonate, cyclic block copolymer, polymethyl methacrylate, and any combination thereof.

5. The progressive addition lens of claim 3, wherein the liquid material is selected from water, silicone oil, and combination thereof.

6. The progressive addition lens of claim 3, wherein the gas material is selected from air, oxygen, nitrogen, and combination thereof.

7. The progressive addition lens of claim 3, wherein when the second lens layer is made of liquid material or gas material, the first lens layer and the third lens layer form a cavity, the liquid material or the gas material is filled in the cavity, to form the second lens layer.

8. The progressive addition lens of claim 1, wherein the progressive addition lens further comprises at least one coating layer secured to the first lens layer and/or the third lens layer.

9. The progressive addition lens of claim 8, wherein the coating layer is an anti-scratch layer, an anti-reflection layer, an anti-fog layer, an anti-dust layer, a water-repelling layer, or an anti-UV layer.

10. A progressive addition glasses comprising:
a glasses frame; and
at least one progressive addition lens embedded on the glasses frame, each progressive addition lens comprising:
a first lens layer;
a second lens layer attached to a surface of the first lens layer; and
a third lens layer attached to a surface of the second lens layer away from the first lens layer;
wherein the first lens layer, the second lens layer, and the third lens layer are made of different materials.

11. The progressive addition glasses of claim 10, wherein the first lens layer and the third lens layer are made of solid material.

12. The progressive addition glasses of claim 11, wherein the second lens layer is made of solid material, liquid material or gas material.

13. The progressive addition glasses of claim 12, wherein the solid material is selected from polycarbonate, cyclic block copolymer, polymethyl methacrylate, and any combination thereof.

14. The progressive addition glasses of claim 12, wherein the liquid material is selected from water, silicone oil, and combination thereof.

15. The progressive addition glasses of claim 12, wherein the gas material is selected from air, oxygen, nitrogen, and combination thereof.

16. The progressive addition glasses of claim 12, wherein when the second lens layer is made of liquid material or gas material, the first lens layer and the third lens layer form a cavity, the liquid material or the gas material is filled in the cavity, to form the second lens layer.

17. The progressive addition glasses of claim 10, wherein the progressive addition lens further comprises at least one coating layer secured to the first lens layer and/or the third lens layer.

18. The progressive addition glasses of claim 17, wherein the coating layer is an anti-scratch layer, an anti-reflection layer, an anti-fog layer, an anti-dust layer, a water-repelling layer, or an anti-UV layer.
